(19) United States
(12) Patent Application Publication
(10) Pub. No.: US 2019/0359408 A1
(43) Pub. Date: Nov. 28, 2019

(54) Packaged Food Product and Method of Packaging

(71) Applicant: General Mills, Inc., Minneapolis, MN (US)

(72) Inventors: Scott Kackman, New Hope, MN (US); Allison Spaeth, Plymouth, MN (US); Katherine Knutson, Jordan, MN (US)

(73) Assignee: General Mills, Inc., Minneapolis, MN (US)

(21) Appl. No.: 15/985,798

(22) Filed: May 22, 2018

(51) Int. Cl. B65D 77/08; B65D 77/04; B65D 77/30

(52) U.S. Cl. CPC B65D 77/08; A21D 8/02; B65D 77/30; B65D 77/0486

(57) ABSTRACT

A packaged food product includes a container having at least one sidewall, a first end closure sealing a first end of the container and a second end closure sealing a second end of the container. The packaged food product also includes at least one dough product and a cup within the container. The cup has at least one sidewall, a bottom wall and a slit in the at least one sidewall. The at least one sidewall of the cup contacts the at least one sidewall of the container upon inserting the cup into the container, with the slit allowing deflection of the cup sidewall during insertion and a reduction in a required insertion force. The packaged food product further includes at least one additional food ingredient within the cup.

### BACKGROUND OF THE INVENTION

The invention pertains to the art of food production and, particularly, to a packaged food product, as well as a method of packaging the food product. More specifically, the present invention relates to a tubular container for packaging dough products where one or more additional ingredients are provided in a separate region within the tubular container.

Due to the time demands placed on consumers by the everyday activities of modern life, the preparation of food products and meals from scratch has decreased and the popularity of premade or partially premade foods has increased dramatically. One type of food product that has become increasingly popular in premade configurations are dough-based food products such as, for example, developed and undeveloped dough products. These dough products can be stored in either a refrigerated or frozen state for extended periods and are “freshly” prepared in a matter of minutes as desired by the consumer. In some instances, these dough products can represent a substantially final product requiring only a heating or baking step such as, for example, cookies, bread, breadsticks, biscuits, rolls and croissants. Alternatively, these dough products can represent components or building blocks of a final product such as, for example, a pie crust or pizza dough that will be combined with a variety of other ingredients to form the final product. Regardless of whether the dough product itself constitutes a final product or merely a component of the final product, these dough products constitute enormous time savers for the consumer in that the consumer need not prepare the dough products from scratch using base ingredients such as, for example, flour, water, eggs, yeast, salt, sugar and the like.

One popular method for packaging and storing dough products has been to use a can format where the dough product is contained within a cylindrical paperboard body having caps at both ends of the body. In such a container, the can body is torn open by the consumer to expose the can contents and enable the removal of individual dough products without substantial product deformation. Depending upon the dough product, these cans can be constructed to withstand substantial internal pressures. While the can format does work very well for dough products alone, there are some instances in which it is desirable to include additional ingredients with the dough product to complete or enhance enjoyment of the final cooked dough product. Such additional ingredients can include, for example, condiments, fruits, icing, spices, nuts, candies and the like. To accommodate these additional ingredients in a can format, a variety of designs have been utilized for separating the additional ingredients from the dough. Certain known configurations employ the use of separate cups to store the additional ingredients. While cups can be successfully used to separate and store dough products and additional ingredients in a can format, it can be challenging to consistently insert the cups into the cans due to both cup-to-cup and can-to-can size variations. In theory, tighter manufacturing tolerances could be employed. However, this is typically expensive. Accordingly, it would be desirable to provide another, more cost-effective way to facilitate the insertion of cups into cans when packaging dough products with additional ingredients.

### SUMMARY OF THE INVENTION

The present invention provides a cup including at least one sidewall, a bottom wall and at least one slit in the at least one sidewall. The cup also includes a rim defining an opening opposite the bottom wall. The slit extends from the rim toward the bottom wall. When the cup is inserted into a container, the slit allows the at least one sidewall of the cup to deform or deflect inward. The slit also creates an air passage so that, during insertion, air within the container can travel from the space below the cup, along the at least one sidewall, through the air passage and to the space above the cup. Accordingly, less force is needed to insert the cup into the container.

Overall, in accordance with a preferred embodiment of the invention, the packaging process generally involves sealing a first end of the container with a first end closure and then depositing one or more dough products into the container through an opening at a second opposite end of the container. Next, the cup is inserted into the container through the opening and filled with one or more additional food ingredients. Afterwards, the second end of the container is sealed with a second end closure to close the opening. During storage, the dough products proof and expand, thereby forcing the at least one sidewall of the cup into contact with the second end closure.

In one exemplary embodiment, the above packaging and method are used with icing and a plurality of cinnamon rolls, and the at least one sidewall of the container comprises a spirally-wound construction of an inner liner layer, an outer label layer and one or more intermediate layers of composite material. The container and cup are both cylindrical, with an outer surface of the cup contacting an inner surface of the container.

Additional objects, features and advantages of the invention will become more readily apparent from the following detailed description of preferred embodiments thereof when taken in conjunction with the drawings wherein like reference numerals refer to common parts in the several views.

### BRIEF DESCRIPTION OF THE DRAWINGS

FIG. 1 is a perspective view of a packaged food product produced in accordance with the present invention;

FIG. 2 is a perspective view of a cup of the packaged food product;

FIG. 3 is a cross-section of the cup;

FIG. 4 is a cross-section of the packaged food product;

FIG. 5 is a perspective view of a second embodiment of the cup;

FIG. 6 is a perspective view of a third embodiment of the cup; and

FIG. 7 is a perspective view of a fourth embodiment of the cup.

### DETAILED DESCRIPTION OF THE INVENTION

Detailed embodiments of the present invention are disclosed herein. However, it is to be understood that the disclosed embodiments are merely exemplary of the invention that may be embodied in various and alternative forms. The figures are not necessarily to scale, and some features may be exaggerated or minimized to show details of particular components. Therefore, specific structural and functional details disclosed herein are not to be interpreted as limiting, but merely as a representative basis for teaching one skilled in the art to employ the present invention.

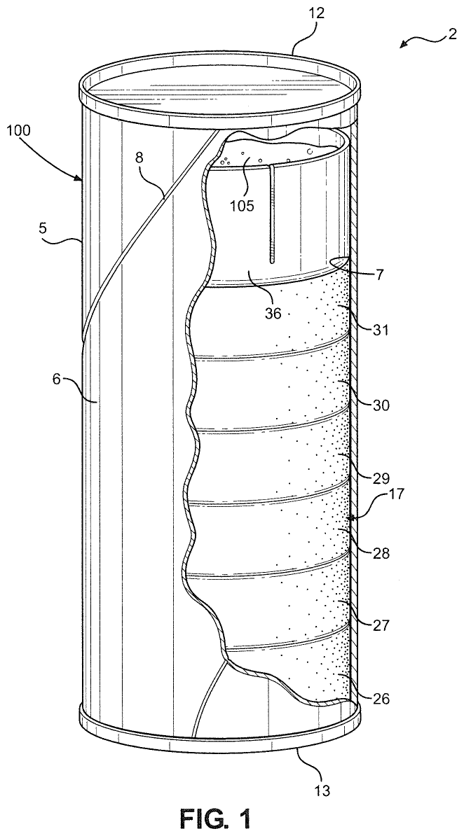

With initial reference to FIG. 1, there is shown a packaged food product 2 produced in accordance with the present invention. Packaged food product 2 comprises a container or can 100. Can 100 takes the form of a tube and includes a sidewall 5 having an outer surface 6 and an inner surface 7. In the embodiment shown, sidewall 5 is made of a composite material (e.g., paperboard) and includes a spiral seam 8. Specifically, sidewall 5 comprises a spirally-wound construction of an inner liner layer of plastic and/or foil, an outer paper label layer and one or more intermediate layers of thin paperboard. Can 100 is closed at both ends, such as with first and second end closures or endcaps 12 and 13, which are crimped, seamed or otherwise secured to the top and bottom of sidewall 5 to establish an interior cavity 17. Endcaps 12 and 13 can be made from metal or plastic, for example.

A plurality of dough products is located within interior cavity 17. Specifically, in the embodiment shown, interior cavity 17 contains a plurality of stacked dough products 26-31 in the form of dough discs, which are used to make cinnamon rolls. However, at this point, it should be realized that the invention can be utilized in packaging various types of dough products, including dough discs, one or more sheets of dough or even a block of dough, for making a wide range of final products, including cookies, bread, biscuits, rolls, croissants, pie crust, pizza dough and the like.

Dough products 26-31 can generate substantial pressure within can 100 during storage. In particular, dough products 26-31 undergo chemical reactions and generate gas pressure in a process known as “proofing”. Preferably, can 100 is configured to withstand internal pressures in the range of 8 to 35 psi (55 to 241 kPa) so that can 100 remains intact over the shelf life of dough products 26-31. To withstand such pressure, endcaps 12 and 13 engage end portions of sidewall 5, either through a process of crimping or seaming, to retain dough products 26-31 despite significant force acting directly or indirectly on endcaps 12 and 13.

A cup 36 is shown positioned above dough products 26-31 within interior cavity 17. At least one additional food ingredient for use with dough products 26-31 is located within cup 36. For example, in the embodiment shown where dough products 26-31 constitute discs used to make cinnamon rolls, cup 36 contains an additional food ingredient 105 in the form of icing, which can be spread upon the cooked cinnamon rolls. In other embodiments, cup 36 can contain other ingredients such as garlic, herbs, spices, seasoning, cheese, butter, condiments, sauces, fruits, nuts, candies or the like. If desired, cup 36 can contain a plurality of additional food ingredients or multiple cups can be provided within interior cavity 17, each containing an additional food ingredient.

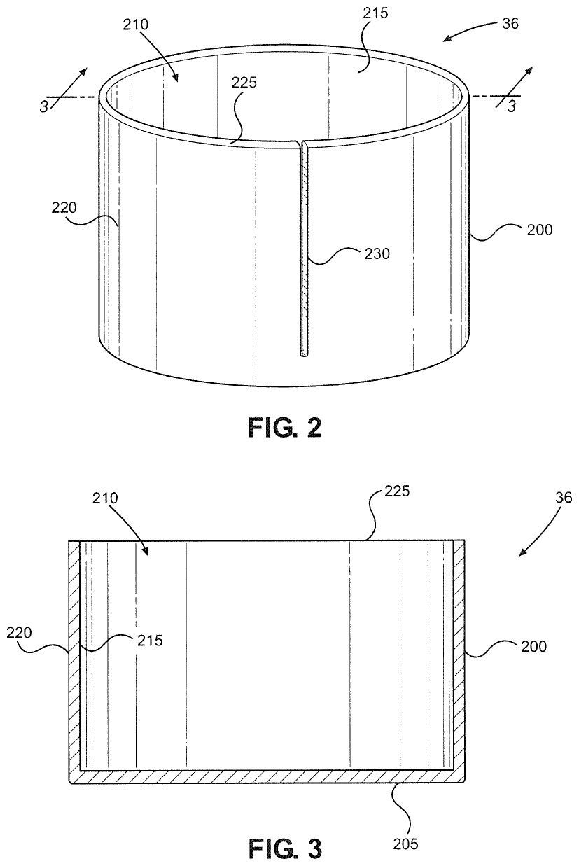

With reference now to FIGS. 2 and 3, cup 36 is shown separate from the rest of packaged food product 2. Cup 36 is cylindrical and includes a sidewall 200 and a bottom wall 205, which together define a receiving cavity 210 for one or more additional food ingredients. Sidewall 200 has an inner surface 215 and an outer surface 220. When cup 36 is located within can 100, outer surface 220 contacts can 100, specifically inner surface 7 of sidewall 5 (shown in FIG. 1). Cup 36 further includes a rim 225, which defines an opening opposite bottom wall 205, and a slit 230, which extends from rim 225 toward bottom wall 205. The inclusion of slit 230 in sidewall 200 advantageously allows sidewall 200 to deform or deflect inward during insertion of cup 36 into can 100, thereby reducing the force needed to insert cup 36 into can 100. In addition, slit 230 acts as an air passage so that, during insertion, air within can 100 can travel from the space below cup 36, along sidewall 200 (between outer surface 220 and inner surface 7), through the air passage and to the space above cup 36. This also reduces the force needed to insert cup 36 into can 100. Beyond insertion of cup 36 into can 100, such an air passage can provide benefits during proofing of dough products 26-31 if it is desired to allow the gas produced during proofing to vent past cup 36.

As should be recognized by one of ordinary skill in the art, slit 230 (possibly multiple, annularly spaced slits 230) can be formed in cup 36 in a variety of ways. For example, slit 230 can be formed during injection molding of cup 36 or by cutting into sidewall 200 after cup 36 is formed. Additionally, although cup 36 is shown as being cylindrical, it should be realized that other shapes can be used with the present invention. For example, cup 36 can have a polygonal cross section with multiple sidewalls. However, it is preferred that the exterior of cup 36 has the same general shape as the interior of can 100 so as to fit fairly tightly within can 100 to prevent dough products 26-31 from expanding into gaps between cup 36 and can 100. Along these same lines, it should be realized that can 100 can have different shapes in other embodiments. In addition, while only one slit 230 is shown, multiple slits can be formed in sidewall 200, if desired, to establish a plurality of sidewall “fingers” cantilevered from an annular sidewall base portion. In one particularly preferred embodiment, three slits 230 are formed in sidewall 200, with slits 230 being evenly annularly spaced from one another (i.e., by) 120°. Of course, other numbers of slits 230 can be provided in other embodiments (e.g., two, four, five, etc.), and slits 230 need not be evenly annularly spaced around sidewall 200. Furthermore, to enhance airflow, including during insertion of cup 36 into can 100, a portion of sidewall 200 near bottom wall 205 can be tapered inward away from sidewall 5, with slit 230 extending to this tapered portion such that air below cup 36 can more readily enter slit 230 and travel to the space above cup 36. Certainly though, other modifications can be made to cup 36, can 100 or both to enhance airflow from the space below cup 36 to the space above cup 36, if desired.

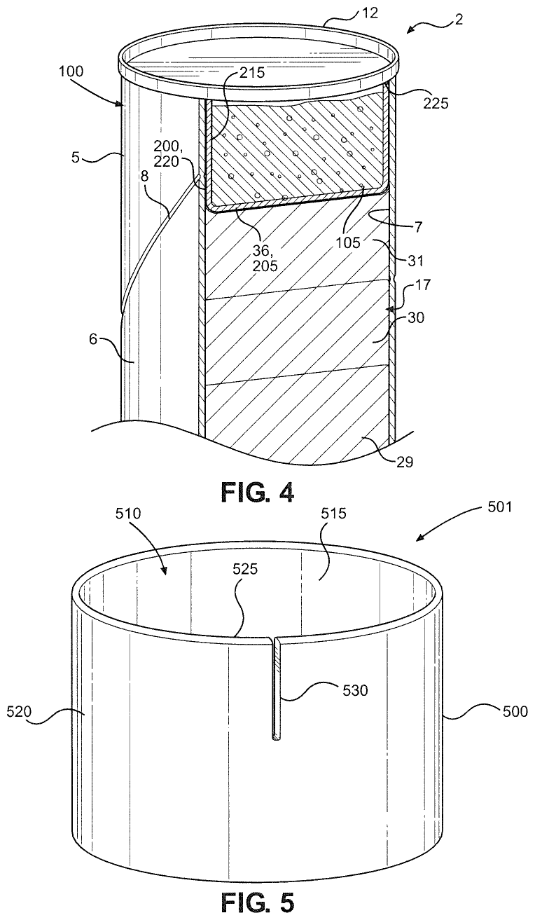

FIG. 4 is a cross-section of packaged food product 2. This view allows more of additional food ingredient 105 to be seen within cup 36. As discussed above, in the embodiment shown, additional food ingredient 105 comprises icing, which can be spread upon dough products 26-31 after dough products 26-31 are baked. While the icing is in direct contact with cup 36 in FIG. 4, in other embodiments, the icing is provided in a pouch, with this pouch being located in cup 36. Of course, such an arrangement is not limited to icing but can also be used with the other additional food ingredients listed above (e.g., garlic, herbs, spices, seasoning, cheese, butter, condiments, sauces, fruits, nuts, candies, etc.).

During packaging in accordance with a preferred embodiment, one end of can 100 is sealed using second endcap 13 (visible in FIG. 1). Then, dough products 26-31 are deposited into can 100 through an opening at the opposite end of can 100 such that dough product 26 contacts second endcap 13. Next, cup 36 is inserted into can 100 through the opening until bottom wall 205 of cup 36 contacts dough product 31, with the inclusion of slit 230 in sidewall 200 of cup 36 reducing the amount of force needed to insert cup 36 into can 100. After insertion, an additional food ingredient 105 (in free or pouched form) is added to cup 36. With the construction of cup 36, inner surface 7 of sidewall 5 can seal off slit 230. Then, the open end of can 100 is sealed with first endcap 12 to close the opening. Typically, cup 36 is not in contact with first endcap 12 at this point, as shown in FIG. 1. Instead, during storage, dough products 26-31 proof and expand, thereby causing cup 36 to move toward first endcap 12 until sidewall 200 of cup 36 contacts first endcap 12, as shown in FIG. 4.

Although one particular packaging method has been described, it should be recognized that other packaging methods can be used with the present invention. For example, cup 36 can be inserted into can 100 before dough products 26-31. In addition, a separate cap (not shown) can be employed to close off the open end of cup 36.

With reference now to FIG. 5, a second embodiment of the cup is shown. Specifically, FIG. 5 shows a cup 501, which is constructed in the same manner as cup 36 except that a slit 530 of cup 501 is shorter than slit 230 of cup 36. Since the other portions of cup 501 (i.e., portions labeled 500, 510, 515, 520 and 525) are the same as those of cup 36 (i.e., same as 200, 210, 215, 220 and 225, respectively), this structure will not be described other than to note that the reference numerals used with cup 36 have been incremented by 300 in FIG. 5 (e.g., both 200 and 500 designate a sidewall).

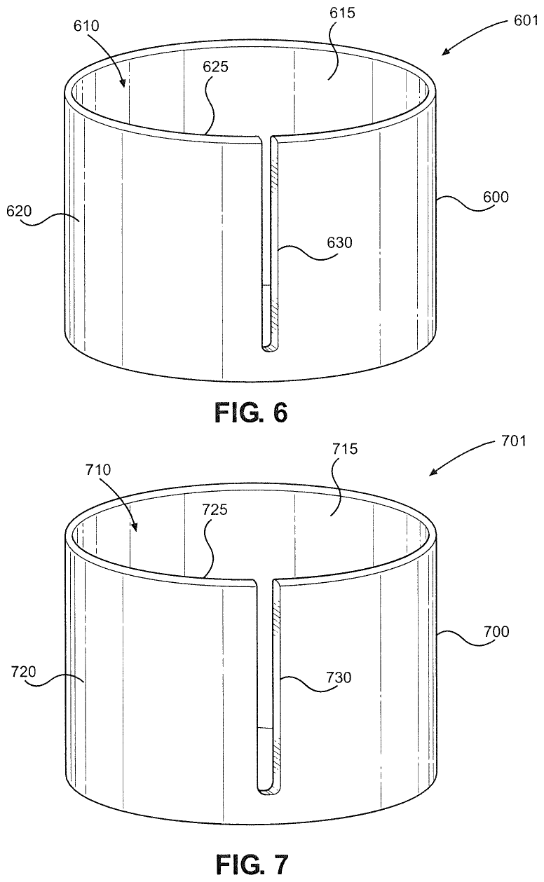

Similarly, FIG. 6 shows a cup 601, which represents a third cup embodiment, and FIG. 7 shows a cup 701, which represents a fourth cup embodiment. Again, cups 601 and 701 are constructed in the same manner as cup 36 except that a slit 630 of cup 601 is wider than slit 230 of cup 36 and a slit 730 of cup 701 is even wider than slit 630. Again, the other portions of cups 601 and 701 (i.e., 600, 610, 615, 620 and 625; 700, 710, 715, 720 and 725) are the same as those of cup 36 (i.e., same as 200, 210, 215, 220 and 225, respectively), and this structure will not be described other than to note that the reference numerals used with cup 36 have been incremented by 400 in FIGS. 6 and 500 in FIG. 7 (e.g., 200, 600 and 700 all designate a sidewall).

While the dimensions of the cups can vary, certain exemplary dimensions are provided below for illustration purposes. Particularly, in the embodiments shown having a cup height in the order of 1 ¼ inches (3.18 cm), slit 230 has a length of 1 inch (2.54 cm) and a width of 1/16 inches (0.159 cm), while slit 530 has a length of ½ inches (1.27 cm) and a width of 1/16 inches (0.159 cm), slit 630 has a length of 1 inch (2.54 cm) and a width of 3/32 inches (0.238 cm), and slit 730 has a length of 1 inch (2.54 cm) and a width of ⅛ inches (0.318 cm). Although each embodiment was found to reduce the force needed to insert the cup into the can (relative to a control cup without a slit), the longer slits (i.e., slits 230, 630 and 730) provided a significantly greater reduction in required insertion force than the shorter slit (i.e., slit 530). By way of example, for the slit dimensions provided above, a sample of control cups without slits required an average peak force of 40.7 N for insertion (with a standard deviation of 6.01 N), a sample of cups 36 required an average peak force of 6.05 N for insertion (with a standard deviation of 0.890 N), and a sample of cups 601 required an average peak force of 4.76 N for insertion (with a standard deviation of 1.16 N). Based on this data, it should be recognized that the inclusion of a slit in a sidewall of a cup can reduce the force needed to insert the cup into a can by over 50% (and up to nearly 90% in some embodiments). It can also be seen that a longer slit provides a greater force reduction. This is, at least in part, because the air below the cup reaches the slit more quickly when the slit is closer to the bottom of the cup.

Based on the above, it should be readily apparent that the present invention provides a cost-effective way to facilitate the insertion of cups into cans when packaging dough products with additional ingredients. While certain preferred embodiments of the present invention have been set forth, it should be understood that various changes or modifications could be made without departing from the spirit of the present invention. In general, the invention is only intended to be limited by the scope of the following claims.

1. A packaged food product comprising:
a container including at least one sidewall, a first end closure sealing a first end of the container and a second end closure sealing a second end of the container;
at least one dough product within the container;
a cup within the container, wherein the cup includes at least one sidewall, a bottom wall and a slit in the at least one sidewall, with the at least one sidewall of the cup contacting the at least one sidewall of the container; and
at least one additional food ingredient within the cup.

2. The packaged food product of claim 1, wherein the cup includes a rim defining an opening opposite the bottom wall, and the slit extends from the rim toward the bottom wall.

3. The packaged food product of claim 1, wherein the slit is configured to allow the at least one sidewall of the cup to deform or deflect inward during insertion of the cup into the container.

4. The packaged food product of claim 1, wherein the slit has a length greater than or equal to ½ inches.

5. The packaged food product of claim 1, wherein the at least one sidewall of the container has an inner surface, the at least one sidewall of the cup has an outer surface, and the inner surface contacts the outer surface within the container.

6. The packaged food product of claim 1, wherein an overall shape of the at least one sidewall of the container is the same as an overall shape of the at least one sidewall of the cup.

7. The packaged food product of claim 6, wherein both the container and the cup are cylindrical in shape.

8. The packaged food product of claim 1, wherein the at least one sidewall of the container comprises a spirally-wound construction of an inner liner layer, an outer label layer and one or more intermediate layers of composite material.

9. (canceled)

10. The packaged food product of claim 1, wherein the container is configured to withstand an internal pressure greater than or equal to 8 psi.

11. A method of packaging a food product comprising:
sealing a first end of a container with a first end closure, wherein the container includes at least one sidewall;
depositing at least one dough product into the container through an opening at a second opposite end of the container;
inserting a cup, including at least one sidewall, a bottom wall and a slit in the at least one sidewall, into the container through the opening, with the at least one sidewall of the cup contacting the at least one sidewall of the container;
adding at least one additional food ingredient to the cup; and
sealing the second end of the container with a second end closure to close the opening.

12. The method of claim 11, further comprising: causing the at least one sidewall of the cup to deform or deflect inward due to engagement with the at least one sidewall of the container during insertion of the cup into the container.

13. The method of claim 11, wherein depositing the at least one dough product into the container includes depositing the at least one dough product such that the at least one dough product contacts the first end closure.

14. The method of claim 11, wherein inserting the cup into the container includes inserting the cup such that the bottom wall of the cup contacts the at least one dough product.

15. The method of claim 14, further comprising: allowing the at least one dough product to proof and expand during storage, thereby forcing the at least one sidewall of the cup into contact with the second end closure.

16. The method of claim 11, wherein the at least one sidewall of the container has an inner surface, the at least one sidewall of the cup has an outer surface, and inserting the cup into the container includes inserting the cup such that the inner surface contacts the outer surface.

17. (canceled)

18. The method of claim 11, wherein the cup includes a rim defining an opening opposite the bottom wall, and the slit extends from the rim toward the bottom wall.

19. The method of claim 11, wherein the container and cup are cylindrical.

20. The method of claim 11, wherein the at least one sidewall of the container comprises a spirally-wound construction of an inner liner layer, an outer label layer and one or more intermediate layers of composite material.

21. The packaged food product of claim 1, wherein the at least one sidewall of the cup is parallel to the at least one sidewall of the container.

22. The packaged food product of claim 1, wherein the slit is parallel to the at least one sidewall of the container.

23. The packaged food product of claim 1, wherein the bottom wall of the cup is flat.
